(19) United States
(12) Patent Application Publication
(10) Pub. No.: US 2026/0159296 A1
(43) Pub. Date: Jun. 11, 2026

(54) PACKAGE FOR CONTAINERS

(71) Applicant: Graphic Packaging International, LLC, Atlanta, GA (US)

(72) Inventors: Claudia Simon, Barcelona (ES); Ana Maria Gonzalez Manzano, Barcelona (ES)

(21) Appl. No.: 19/410,048

(22) Filed: Dec. 5, 2025

Related U.S. Application Data
(60) Provisional application No. 63/728,850, filed on Dec. 6, 2024.

(51) Int. Cl. B65D 71/48; B31B 50/26; B31B 100/00; B31B 110/10; B31B 120/40; B65D 17/28

(52) U.S. Cl. CPC B65D 71/48; B31B 50/262; B65D 17/402; B31B 2100/0022; B31B 2110/10; B31B 2120/40; B31B 2241/001; B65D 2517/0013

(57) ABSTRACT

A carrier for holding a plurality of containers, the carrier includes a bottom panel having a plurality of container retention features. The carrier has a front portion comprising a first portion of the bottom panel, at least one front side panel, and a front reinforcement panel. The carrier has a back portion comprising a second portion of the bottom panel, at least one back side panel, and a back reinforcement panel. A reinforcement portion extends from the front portion to the back portion for reinforcing the carrier and comprises the front reinforcement panel and the back reinforcement panel in at least partial face-to-face contact. The carrier can include access features for access one or more container of the plurality of containers and handle features for forming a handle for grasping and carrying the carrier.

### CROSS-REFERENCED TO RELATED APPLICATIONS

This application claims the benefit of U.S. Provisional Patent Application No. 63/728,850 , filed on Dec. 6, 2024.

### INCORPORATION BY REFERENCE

The disclosure of U.S. Provisional Patent Application No. 63/728,850, which was filed on Dec. 6, 2024, is hereby incorporated by reference for all purposes as if presented herein in their entirety.

### BACKGROUND OF THE DISCLOSURE

The present disclosure generally relates to packages or carrier cartons for holding and displaying containers. More specifically, the disclosure is directed to a carrier having features for at least partially retaining the containers in the package.

### SUMMARY OF THE DISCLOSURE

In general, one aspect of the disclosure is directed to a carrier for holding a plurality of containers, the carrier includes a bottom panel having a plurality of container retention features. The carrier has a front portion comprising a first portion of the bottom panel, at least one front side panel, and a front reinforcement panel. The carrier has a back portion comprising a second portion of the bottom panel, at least one back side panel, and a back reinforcement panel. A reinforcement portion extends from the front portion to the back portion for reinforcing the carrier and comprises the front reinforcement panel and the back reinforcement panel in at least partial face-to-face contact. The carrier can include access features for access one or more container of the plurality of containers and handle features for forming a handle for grasping and carrying the carrier.

In another aspect, the disclosure is generally directed to carrier for holding a plurality of containers. The carrier comprises a bottom panel for at least partially receiving a respective container of the plurality of containers, the bottom panel having a plurality of container retention features for at least partially engaging a respective container of the plurality of containers. The plurality of container retention features comprise a respective bottom container retention opening and a respective plurality of bottom container retention flaps foldably connected to the bottom panel and cooperating with the bottom container retention opening to engage a respective container of the plurality of containers. The carrier comprises a front portion comprising a first portion of the bottom panel including front bottom container retention features of the plurality of bottom container retention features, at least one front side panel, and a front reinforcement panel. The carrier comprises a back portion comprising a second portion of the bottom panel including back bottom container retention features of the plurality of bottom container retention features, at least one back side panel, and a back reinforcement panel. The carrier comprises a reinforcement portion extending from the front portion to the back portion for reinforcing the carrier. The reinforcement portion comprises the front reinforcement panel and the back reinforcement panel in at least partial face-to-face contact. The carrier has access features for facilitating access to one or more containers. The access features comprise a plurality of access tabs separably connected to the respective front portion and the back portion of the carrier. The plurality of access tabs are respectively foldably connected to a respective one of the at least one front side panel and the at least one back side panel.

In another aspect, the disclosure is generally directed to a blank for forming a carrier for holding a plurality of containers. The blank comprises a bottom panel for at least partially receiving a respective container of the plurality of containers in the carrier formed from the blank, the bottom panel having a plurality of container retention features for at least partially engaging a respective container of the plurality of containers. The plurality of container retention features comprises a respective bottom container retention opening and a respective plurality of bottom container retention flaps foldably connected to the bottom panel and cooperating with the bottom container retention opening to engage a respective container of the plurality of containers in the carrier formed from the blank. The blank has a front portion for forming a front portion of the carrier formed from the blank. The front portion of the blank comprises a first portion of the bottom panel including front bottom container retention features of the plurality of bottom container retention features, at least one front side panel, and a front reinforcement panel. The blank comprises a back portion for forming a back portion of the carrier formed from the blank. The back portion of the blank comprises a second portion of the bottom panel including back bottom container retention features of the plurality of bottom container retention features, at least one back side panel, and a back reinforcement panel. The front reinforcement panel and the back reinforcement panel are for being in at least partial face-to-face contact in the carrier formed from the blank and for forming a reinforcement portion extending from the front portion of the carrier to the back portion of the carrier and for reinforcing the carrier formed from the blank. The blank comprises access features for facilitating access to one or more containers in the carrier formed from the blank. The access features comprising a plurality of access tabs separably connected to the respective front portion and the back portion of the blank. The plurality of access tabs are respectively foldably connected to a respective one of the at least one front side panel and the at least one back side panel.

In another aspect, the disclosure is generally directed to a method of forming a carrier for holding a plurality of containers. The method comprises obtaining a blank, the blank comprising a bottom panel having a plurality of container retention features comprising a respective bottom container retention opening and a respective plurality of bottom container retention flaps foldably connected to the bottom panel. The blank comprises a front portion and a back portion The front portion of the blank comprising a first portion of the bottom panel including front bottom container retention features of the plurality of bottom container retention features, at least one front side panel, and a front reinforcement panel. The back portion of the blank comprising a second portion of the bottom panel including back bottom container retention features of the plurality of bottom container retention features, at least one back side panel, and a back reinforcement panel. The blank comprises a plurality of access tabs separably connected to the respective front portion and the back portion of the blank. The plurality of access tabs are respectively foldably connected to a respective one of the at least one front side panel and the at least one back side panel. The method comprises positioning the bottom panel to engage a respective container of the plurality of containers and the bottom container retention flaps cooperate with bottom container retention openings to engage a respective container of the plurality of containers. The method comprises forming a front portion of the carrier from the front portion of the blank and forming a back portion of the carrier from the back portion of the blank. The front portion of the carrier and the back portion of the carrier having access features for facilitating access to one or more containers, the access features comprising the plurality of access tabs. The method comprises forming a reinforcement portion of the carrier extending between the front portion of the carrier and the back portion of the carrier by positioning the front reinforcement panel and the back reinforcement panel in at least partially face-to-face contact to reinforce the carrier.

In another aspect, the disclosure is generally directed to a carrier for at least partially holding a plurality of containers. The carrier comprising a bottom panel for at least partially receiving a respective container of the plurality of containers, the bottom panel having container retention features for at least partially engaging a respective container of the plurality of containers. The plurality of container retention features comprises a respective bottom container retention opening and a respective plurality of bottom container retention flaps foldably connected to the bottom panel and cooperating with the bottom container retention opening to engage a respective container of the plurality of containers. The carrier comprises a front portion including a first portion of the bottom panel including front bottom container retention features of the plurality of bottom container retention features, at least one front side panel, and a front reinforcement panel. The carrier comprises a back portion including a second portion of the bottom panel including back bottom container retention features of the plurality of bottom container retention features, at least one back side panel, and a back reinforcement panel. A reinforcement portion extending from the front portion to the back portion for reinforcing the carrier. The reinforcement portion comprises the front reinforcement panel and the back reinforcement panel in at least partial face-to-face contact. The carrier has handle features for forming a handle for grasping and carrying the carrier. The handle features comprise a first handle feature in the front reinforcement panel and a second handle feature in the back reinforcement panel, the first handle feature and the second handle feature form the handle.

In another aspect, the disclosure is generally directed to a blank for forming a carrier for holding a plurality of containers. The blank comprises a bottom panel for at least partially receiving a respective container of the plurality of containers in the carrier formed from the blank, the bottom panel having a plurality of container retention features for at least partially engaging a respective container of the plurality of containers. The plurality of container retention features comprises a respective bottom container retention opening and a respective plurality of bottom container retention flaps foldably connected to the bottom panel and cooperating with the bottom container retention opening to engage a respective container of the plurality of containers in the carrier formed from the blank. The blank comprises a front portion for forming a front portion of the carrier formed from the blank. The front portion of the blank comprises a first portion of the bottom panel including front bottom container retention features of the plurality of bottom container retention features, at least one front side panel, and a front reinforcement panel. The blank comprises a back portion for forming a back portion of the carrier formed from the blank, the back portion of the blank comprising a second portion of the bottom panel including back bottom container retention features of the plurality of bottom container retention features, at least one back side panel, and a back reinforcement panel. The front reinforcement panel and the back reinforcement panel are for being in at least partial face-to-face contact in the carrier formed from the blank and for forming a reinforcement portion extending from the front portion of the carrier to the back portion of the carrier and for reinforcing the carrier formed from the blank. The blank comprises handle features for forming a handle in the carrier formed from the blank. The handle features comprise a first handle feature in the front reinforcement panel and a second handle feature in the back reinforcement panel, the first handle feature and the second handle feature cooperate to form the handle in the carrier formed from the blank.

In another aspect, the disclosure is generally directed to a method of forming a carrier for holding a plurality of containers. The method comprises obtaining a blank. The blank comprises a bottom panel having a plurality of container retention features comprising a respective bottom container retention opening and a respective plurality of bottom container retention flaps foldably connected to the bottom panel. The blank comprises a front portion and a back portion. The front portion of the blank comprises a first portion of the bottom panel including front bottom container retention features of the plurality of bottom container retention features, at least one front side panel, and a front reinforcement panel. The back portion of the blank comprises a second portion of the bottom panel including back bottom container retention features of the plurality of bottom container retention features, at least one back side panel, and a back reinforcement panel. The blank comprises handle features comprising a first handle feature in the front reinforcement panel and a second handle feature in the back reinforcement panel. The method comprises positioning the bottom panel to engage a respective container of the plurality of containers and the bottom container retention flaps cooperate with bottom container retention openings to engage a respective container of the plurality of containers. The method comprises forming a front portion of the carrier from the front portion of the blank and forming a back portion of the carrier from the back portion of the blank. The method comprises forming a reinforcement portion of the carrier extending between the front portion of the carrier and the back portion of the carrier by positioning the front reinforcement panel and the back reinforcement panel in at least partially face-to-face contact to reinforce the carrier. The forming the reinforcement portion comprises forming a handle by positioning the first handle feature and the second handle feature.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is an exterior plan view of a blank for forming a carrier and package according to a first embodiment of the disclosure.

FIG. 1A is an enlarged portion of the blank of FIG. 1.

FIG. 2 is a perspective view of a container for being held in the carrier.

FIG. 3 is a perspective view of the carrier and package of the first embodiment.

FIGS. 3A and 3B are enlarged portions of the carrier and package of the first embodiment.

FIGS. 4-8 are perspective views showing the carrier of the first embodiment being formed by the blank of FIG. 1.

FIGS. 9-12 are perspective views of the carrier of the first embodiment showing activation of access features.

FIGS. 13A-13D show variations of the access features of embodiments of the disclosure.

FIGS. 14-16 are perspective views of the carrier of the first embodiment showing activation of handle features.

FIGS. 17-19 are portions of the blank of FIG. 1 showing the handle features of the blank.

FIG. 20 is an exterior plan view of a blank for forming a carrier and package according to a second embodiment of the disclosure.

FIGS. 20A-20C are portions of the blank of FIG. 20 showing handle features of the blank.

FIGS. 21-28 are various views showing the formation of the carrier and package of the second embodiment.

FIGS. 29-32 are various views showing the activation of the handle features of the second embodiment.

FIG. 33 is an exterior plan view of a blank for forming a carrier and package according to a third embodiment of the disclosure.

FIGS. 34-39 are various views showing the formation of the carrier and package of the third embodiment.

FIGS. 40-43 are various views showing the activation of the handle features of the third embodiment.

Corresponding parts are designated by corresponding reference numbers throughout the drawings.

### DETAILED DESCRIPTION OF THE EXEMPLARY EMBODIMENTS

The present disclosure generally relates to constructs, sleeves, cartons, or the like, and packages for holding and displaying articles such as containers, jars, bottles, cans, etc. The articles can be used for packaging food and beverage products, for example. The articles can be made from materials suitable in composition for packaging the particular food or beverage item, and the materials include, but are not limited to, plastics such as PET, LDPE, LLDPE, HDPE, PP, PS, PVC, EVOH, and Nylon; and the like; aluminum and/or other metals; glass; or any combination thereof.

Carriers according to the present disclosure can accommodate articles of numerous different shapes. For the purpose of illustration and not for the purpose of limiting the scope of the disclosure, the following detailed description describes food or beverage product containers (e.g., plastic containers) at least partially disposed within the carrier embodiments. In this specification, the terms “lower,” “bottom,” “upper,” “top,” “front,” “forward,” “back,” “rear,” “rearward,” “inner,” “outer,” “interior,” and “exterior” indicate orientations determined in relation to fully erected and upright packages or carriers. As described herein, carriers can be formed from blanks with multiple panels, portions, tabs, and/or flaps, which may be designated herein in terms relative to one another, e.g., “first,” “second,” “third,” etc., in sequential or nonsequential reference, without departing from the disclosure.

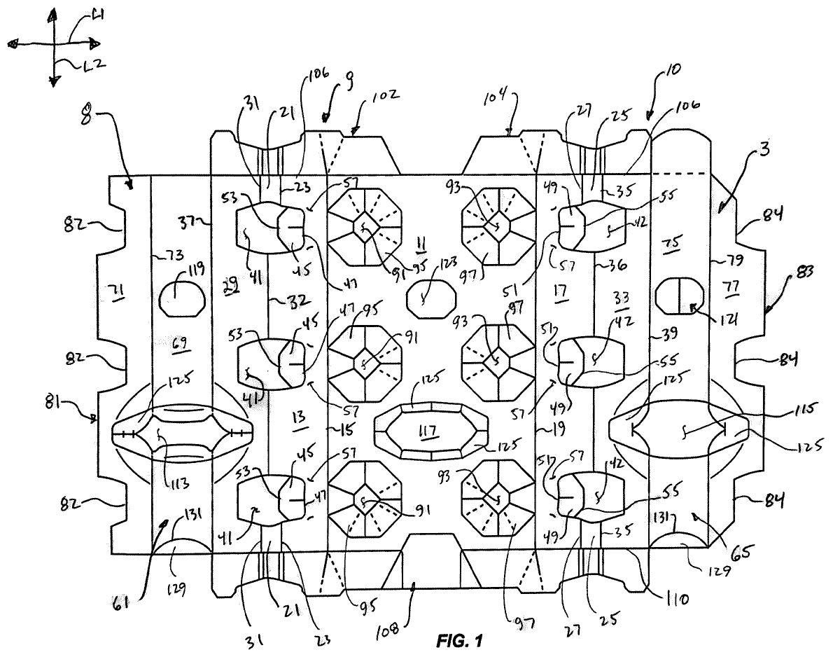

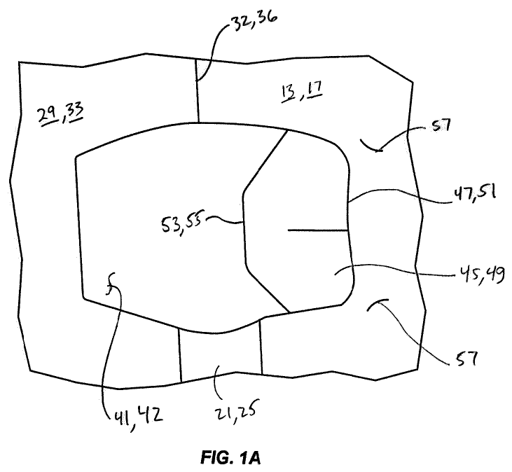

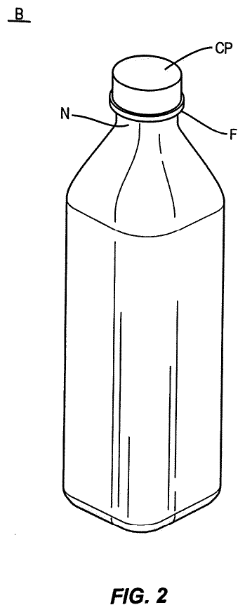

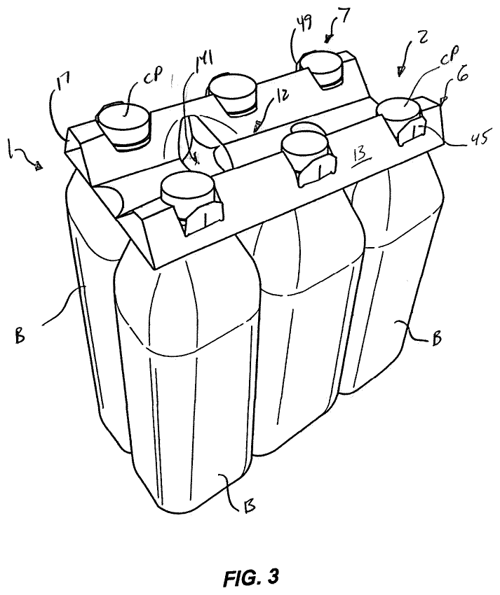

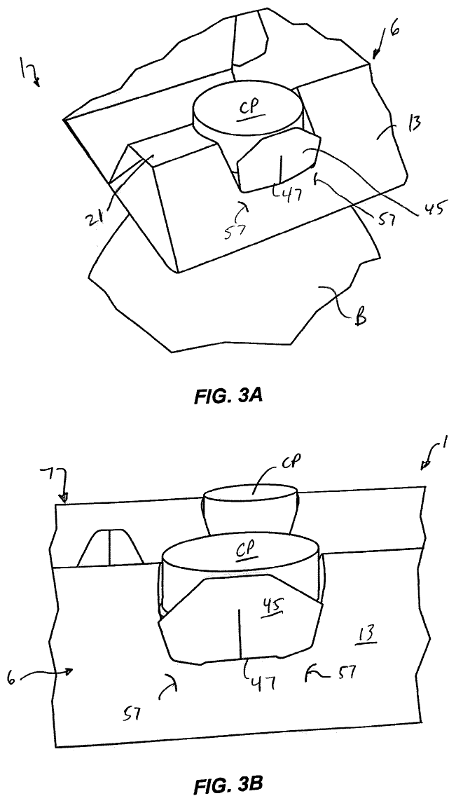

FIG. 1 is a plan view of an exterior side 3 of a blank 8 used to form a carrier 1 (FIG. 3) according to a first embodiment of the disclosure. The carrier 1 can be attached to containers C to form a package 2. In embodiments, the containers B (FIG. 2) are illustrated as beverage containers (e.g., plastic bottles or other suitable containers) having a neck N with a ring or flange F and a cap or top portion CP closing the container B at the top of the containers, but other containers may be retained by the carrier 1 and package 2 without departing from the disclosure. In the illustrated embodiment, the carrier 1 is sized to house six containers B in a single layer in a 3×2 arrangement, but it is understood that the carrier 1 may be sized and shaped to hold containers of a different or same quantity in different row/column arrangements (e.g., 1×6, 2×6, 4×6, 3×8, 3×4, 2×9, 3×6, etc.), or just a single article. In the illustrated embodiment, the blank 8 has a front portion 9 for forming a front portion 6 of the carrier 1 that holds a first or front row of containers B and the blank has a back portion 10 for forming a back portion 7 of the carrier that holds has a second or back row of container B. In various embodiments, the carrier 1 includes access features for facilitating access to the plurality of containers B in the front portion 6 and the back portion 10 and handle features for forming a handle 12 for carrying the carrier 1.

As shown in FIG. 1, the blank 8 has a longitudinal axis L1 and a lateral axis L2. The blank 8 comprises a bottom panel 11 foldably connected to a first or front outer side panel 13 along a first lateral fold line 15, and a second or back outer side panel 17 is foldably connected to the bottom panel 11 along a second lateral fold line 19. A first or front top panel 21 is foldably connected to the front outer side panel 13 along a lateral fold line 23, and a back top panel 25 is foldably connected to the back outer side panel 17 along a lateral fold line 27. A front inner side panel 29 is foldably connected to the front top panel 21 along a lateral fold line 31 and is foldably connected to the front outer top panel 13 at a lateral fold line 32. A back inner side panel 33 is foldably connected to the back top panel 25 along a lateral fold line 35 and is foldably connected to the back outer side panel 17 at a lateral fold line 36. A front reinforcement panel 61 is foldably connected to the front inner side panel 29 along a lateral fold line 37, and a back reinforcement panel 65 is foldably connected to the back inner side panel 33 along a lateral fold line 39.

In the embodiment of FIG. 1, a row of front container retention openings 41 extends in the front inner side panel 29 and the front outer side panel 13, a row of back container retention openings 42 extend in the back outer side panel 17 and the back inner side panel 33. In embodiments, the container retention openings 41, 42 can be shaped to at least partially receive a top portion CP of respective containers B when the blank 8 is formed into the carrier 1. Each of the container retention openings 41 in the front portion 9 of the blank 8 has a respective access tab 45 foldably connected to the front outer side panel 13 at a fold line 47 and each of the container retention openings 42 in the back portion 10 of the blank 8 has a respective access tab 49 foldably connected to the back outer side panel 17 at a fold line 51. As shown in FIG. 1A, each of the access tabs 45, 49 has a respective free edge 53, 55 that extends into a respective container retention opening 41, 42. Each outer side panel 13, 17 includes cuts 57 or other lines of weakening that are forming tear lines in the outer side panels for tearing of the outer side panel from the fold line 47, 51 to a respective fold line 15, 19 and removal of the access tabs 45, 49. The access tabs 45, 49, fold lines 47, 51 and cuts/tear lines 57 form access features of the blank 8 that form the access features of the carrier 1 to allow access and removal of a respective container B from the carrier. Any of the access features of the blank could be otherwise shaped, arranged, and/or configured without departing from the disclosure.

In one embodiment, the front reinforcement panel 61 includes a base portion 69 foldably connected to the front inner side panel 29 and distal portion 71 foldably connected to the base portion at a lateral fold line 73. The back reinforcement panel 65 includes a base portion 75 foldably connected to the back inner side panel 33 and a distal portion 77 foldably connected to the base portion at a lateral fold line 79. The distal portion 71 of the front reinforcement panel 61 has an edge 81 with container engaging features in the form of notches 82 that are shaped to engage a respective container B in the back portion 7 of the carrier 1 and the distal portion 77 of the back reinforcement panel 65 has an edge 83 with container engaging features in the form of notches 84 that are shaped to engage a respective container B in the front portion 6 of the carrier 1. The reinforcement panels 61, 65 could have other feature and could be otherwise shaped, arranged, and/or configured without departing from the disclosure.

As shown in FIG. 1, the bottom panel 11 includes front container retention openings 91 for receiving a portion of a respective container B in the front portion 6 of the carrier 1 and back container retention openings 93 for receiving a portion of a respective container B in the back portion 7 of the carrier 1. The bottom panel includes respective front container retention flaps 95 surrounding a respective front container retention opening 91 and respective back container retention flaps 97 surrounding a respective back container retention opening 93. Each of the container retention flaps 95, 97 is foldably connected to the bottom panel 11 at a respective fold line 99. The container retention flaps 95, 97 and the container retention opening 91, 93 form container retention features in the bottom panel 11 for at least partially engaging a respective container B of the plurality of containers held in the carrier 1. The container retention features could be otherwise shaped, arranged, configured, or omitted without departing from the disclosure.

In the illustrated embodiment, the blank 8 includes first end flaps 102, 104 that extend along a first marginal portion of the blank and are foldably connected to respective panels of the blank at a longitudinal fold line 106. The blank includes a second end flap 108 that extends along a second marginal portion of the blank 8 and is foldably connected to respective panels of the blank at a longitudinal fold line 110. The longitudinal fold lines 106, 108 could be straight or offset at various portions of the blank and the end flaps 102, 104 could have various features and shapes corresponding to the panels of the blank without departing from the disclosure. The end flaps 102, 104 are for being folded inwardly with respect to the panels of the blank 8 at the fold lines 106, 108 to reinforce the carrier 1 formed from the blank. The end flaps 102, 104 could be otherwise shaped, arranged, configured, or omitted without departing from the disclosure.

In the embodiment of FIG. 1, the handle features of the blank 8 include a first handle opening 113 in the front reinforcement panel 61, a second handle opening 115 in the back reinforcement panel 65, and a third handle opening 117 in the bottom panel 11. The handle features further comprise a first access panel 119 in the base portion 69 of the front reinforcement panel 61, a second access panel 121 in the base portion 75 of the back reinforcement panel 65, and an access opening 123 in the bottom panel 11. In the illustrated embodiment, the first handle opening 113 extends across the base portion 69 of the front reinforcement panel 61 and into the front inner side panel 29 and the distal portion 71 of the front reinforcement panel. The second handle opening 115 is similarly shaped as the first handle opening 113 extends across the base portion 75 of the back reinforcement panel 65 and into the back inner side panel 33 and the distal portion 77 of the back reinforcement panel. In one embodiment, the handle features of the blank 8 include respective handle reinforcement panels 125 formed by various lines of weakening (e.g., tear lines, fold lines, cut lines, etc.) adjacent respective handle openings 113, 115, 117. In the illustrated embodiments, the handle features of the blank further include access portions 129 at the edge of respective base portions 69, 75 of the reinforcement flaps 61, 65. As shown in FIG. 1, the access portions 129 are at least partially defined by curved fold lines 131 in the respective base portions 69, 75. In one embodiment, the overlapped handle openings 113, 115, 117 can form a main handle opening 141 of the carrier 1 where the carrier 1 can be grasped to carry the package. The handle features of the blank 8 for forming the handle 12 of the carrier 1, could be otherwise shaped, arranged, configured, and/or omitted without departing from the disclosure.

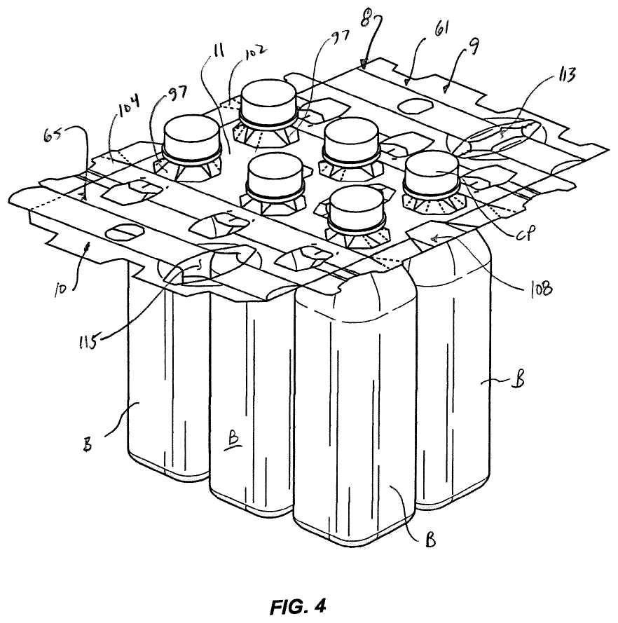

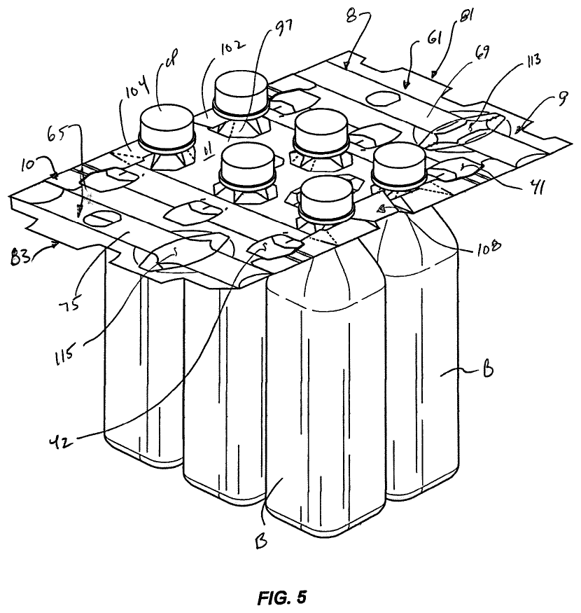

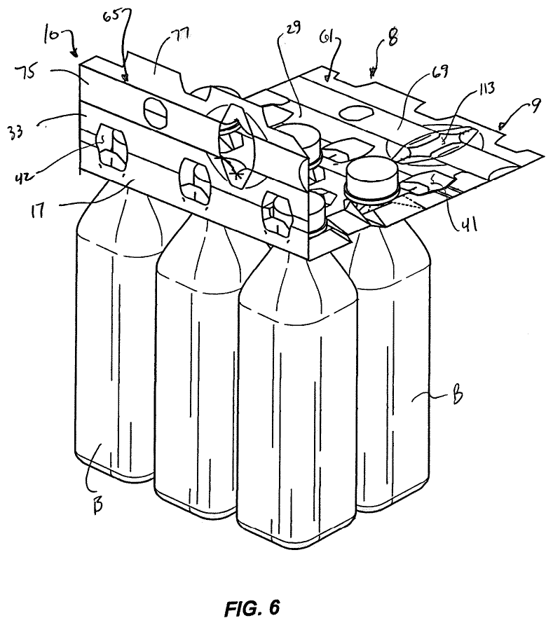

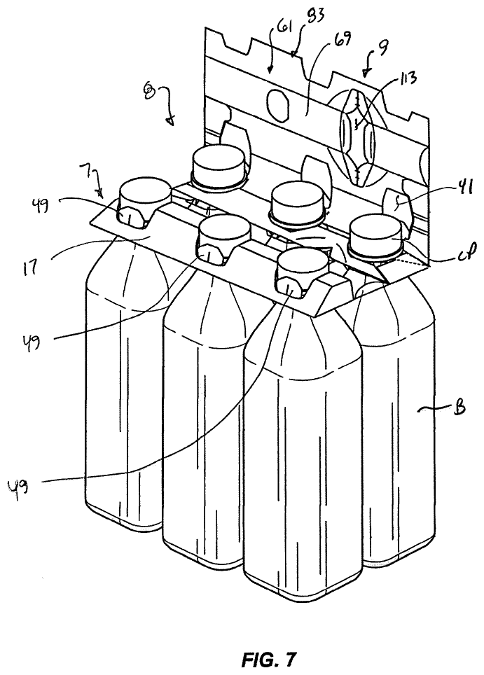

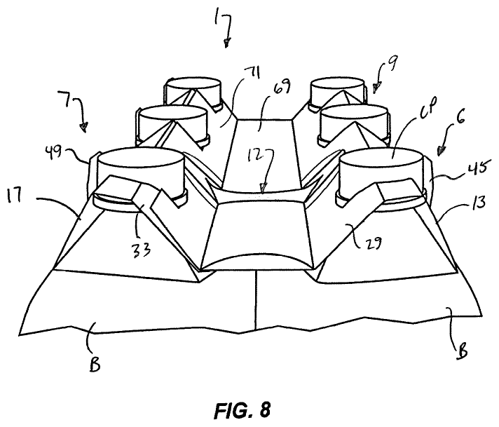

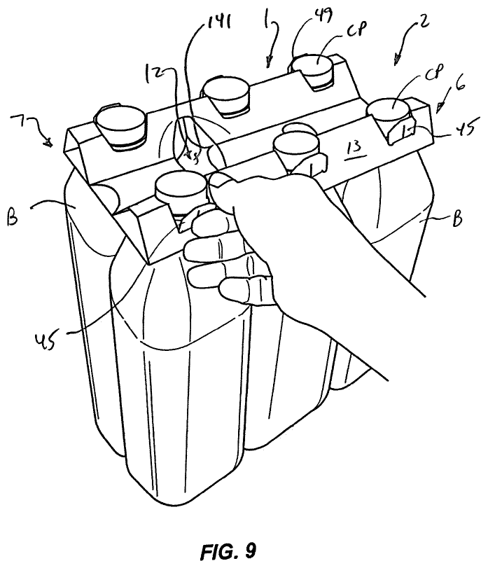

Referring to FIGS. 4-8, an exemplary method of forming the blank 8 into the carrier 1 and package 2 is described in the following. In exemplary embodiments, the blank 8 can be formed into the carrier 1 by inserting the containers B through a respective container retention opening 91, 93 in the bottom panel 11 (FIG. 4). Upon inserting a container B into a respective container retention opening 91, 93, the respective container retention flaps 95, 97 are upwardly folded relative to the bottom panel 11 as the top/caps CP of the container B moves upward relative to the bottom panel 11 through the respective container retention openings 91, 93. The containers B can be inserted into the respective container retention openings 91 in a first row, and the containers B can be inserted into the respective container retention openings 93 in a second row. As shown in FIGS. 4 and 5, the free edges of the container retention flaps 91, 93 can engage and/or contact the underside of the flange F of the respective containers B. As shown in FIG. 5, the end flaps 102, 104, 108 can be folded at respective longitudinal fold lines 106, 110 to be in at least partial face-to-face contact with respective panels of the blank 8. As shown in FIGS. 6 and 7, the front side panels 13, 29 and the front reinforcement panel 61 are folded relative to the bottom panel 11 such that the caps CP of the front row of containers B are received in the respective front container retention openings 41 and the front reinforcement panel 61 overlies and is in at least partial face-to-face contact with the bottom panel 11. The distal portion 71 of the front reinforcement panel 61 can contact and engage respective flanges F of respective containers B in the back row of containers. Similarly, the back side panels 17, 3 and the back reinforcement panel 65 are folded relative to the bottom panel 11 such that the caps CP of the back row of containers B are received in the respective back container retention openings 42 and the back reinforcement panel 65 is folded to overlay and be in at least partial face-to-face contact with the front reinforcement panel 61. The distal portion 77 of the back reinforcement panel 65 can contact and engage respective flanges F of respective containers B in the front row of containers.

As shown in FIG. 8, the overlapped reinforcement panels 61, 65 and a portion of the bottom panel 11 can form a reinforcement portion 141 of the carrier 1 that extends between the front portion 6 of the carrier and the back portion 7 of the carrier such that the reinforcement portion 141 extends between the front row of containers B and the back two rows of containers B and reinforces the carrier 1. Further, the base portion 69 of the front reinforcement panel 61 including the first handle opening 113 and first access panel 119, the base portion 75 of the back reinforcement panel 65 including the second handle opening 115 and second access panel 121, and a central portion of the bottom panel 11 including the third handle opening 117 and the access opening 123 are overlapped to form a central portion of the carrier 1 that includes the handle 12. The carrier 1 and/or package 2 can be formed by other folding steps without departing from the disclosure. Further, various panels or portions of the blank 8 can be adhered together by adhesive such as glue without departing from the disclosure.

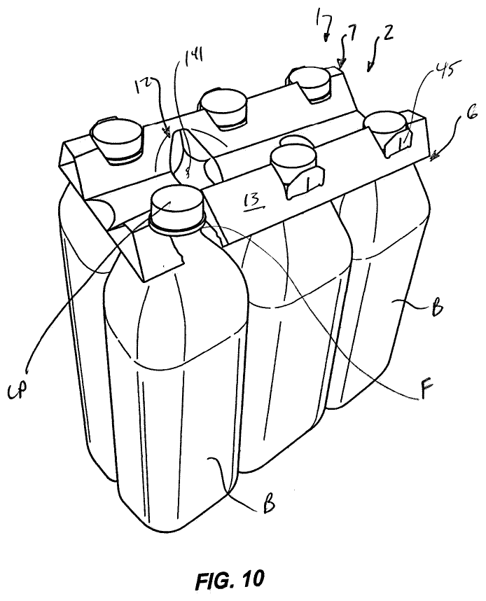

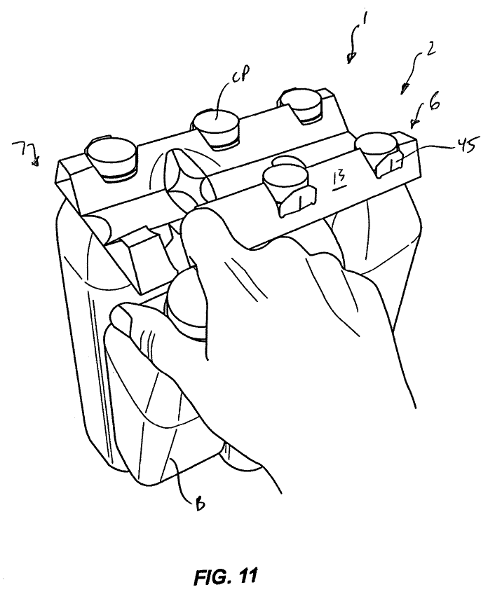

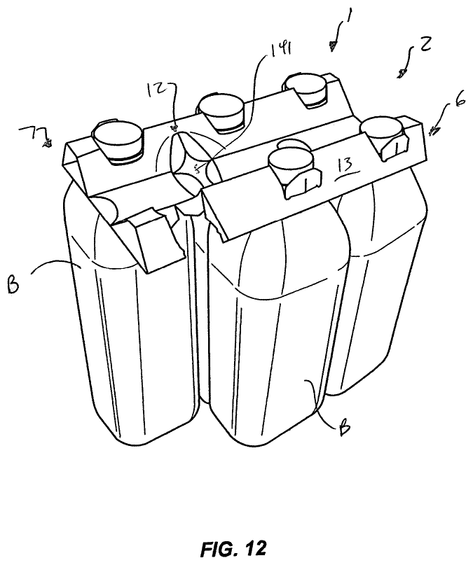

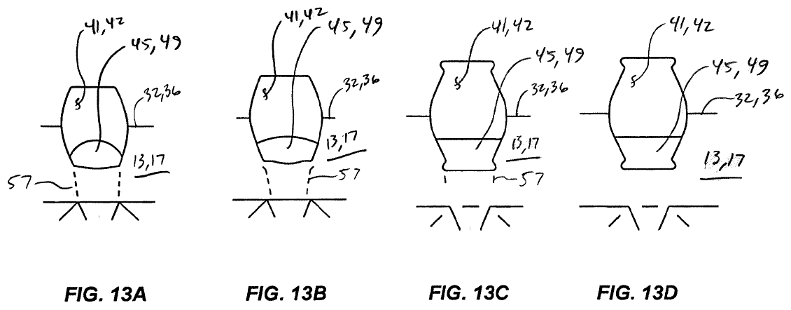

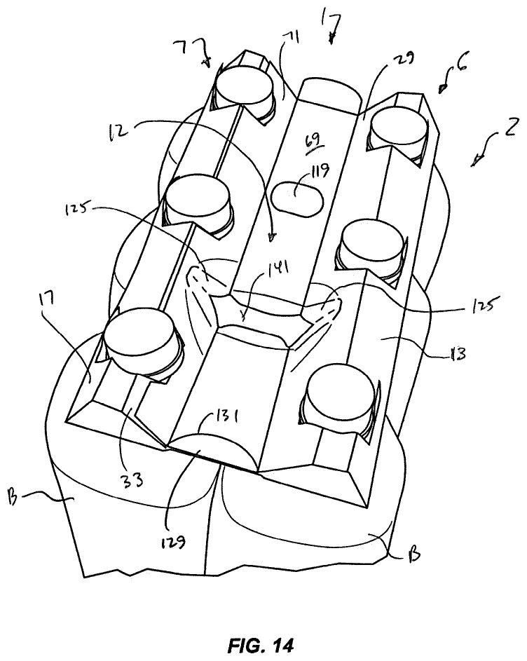

As shown in FIGS. 10-12, the access features can be actuated to facilitate access to the containers B held in the carrier. In the illustrated embodiments, the access tabs 45, 49 can be grasped and pulled downward to tear a respective front outer side panel 13 or back outer side panel 17 at respective cuts/tear lines 57 extending from the access tabs 45, 49. Upon tearing the front outer side panel 13 or back outer side panel 17 are respective container B can be removed from the front portion 6 of the carrier and/or the back portion 7 of the carrier 1. As shown in FIGS. 13A-13D, the access features including the access tabs 45, 49, cuts/tear lines 57, and fold lines 47, 51 can have other exemplary features and shapes without departing from the disclosure. Further, the access features can be otherwise shaped, arranged, configured, or accessed by other steps and method without departing from the disclosure.

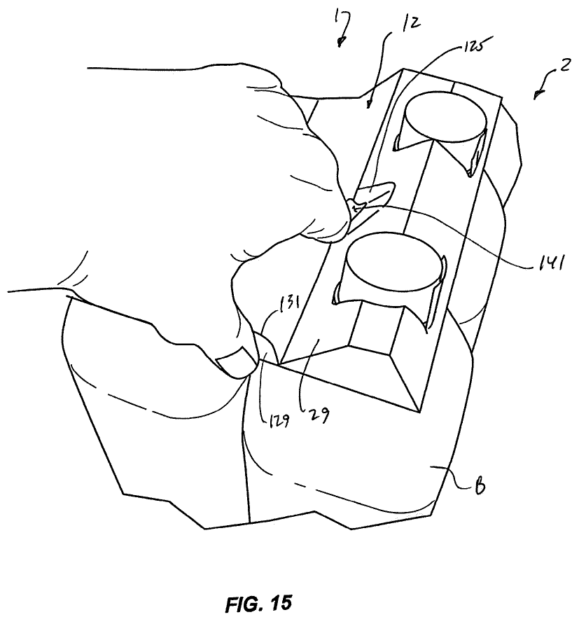

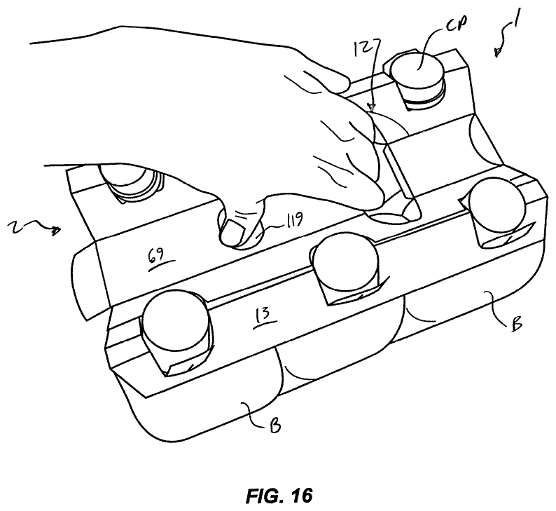

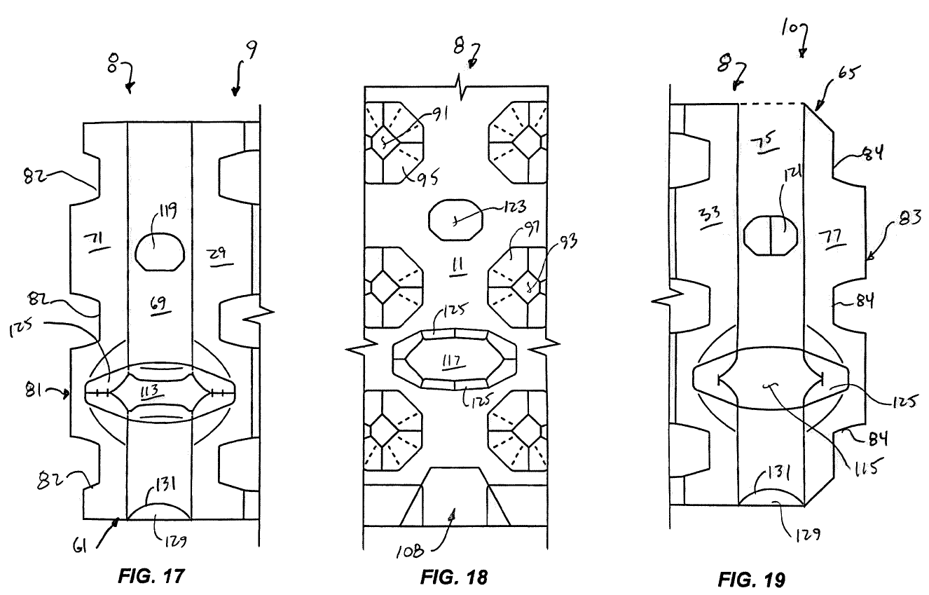

As shown in FIGS. 14-16, the handle features that form the handle 12 can be actuated (e.g., for lifting and carrying the carrier 1 or package 2) by a user inserting a hand through the main handle opening 141 in the central portion of the carrier. In one embodiment (FIG. 15) the main handle opening 141 and the overlapped access portions 129 of the reinforcement panels 61, 65 can be grasped to carry the carrier 1 or package 2 via the handle 12. In another embodiment (FIG. 16), the main handle opening 141 and the overlapped access panels 119, 121 and access opening 123 can be utilized to grasp the carrier 1 or package 2 via the handle 12. Further, in other embodiments only the main handle opening 141 is grasped to carry the carrier 1 or package 2 via the handle. The handle reinforcement panels 125 that overlap and surround a respective handle opening 113, 115, 117 facilitate the user grasping the carrier at the handle 12 by conforming the main handle opening to the hand of the user. The handle 12 can be otherwise formed and otherwise used without departing from the disclosure.

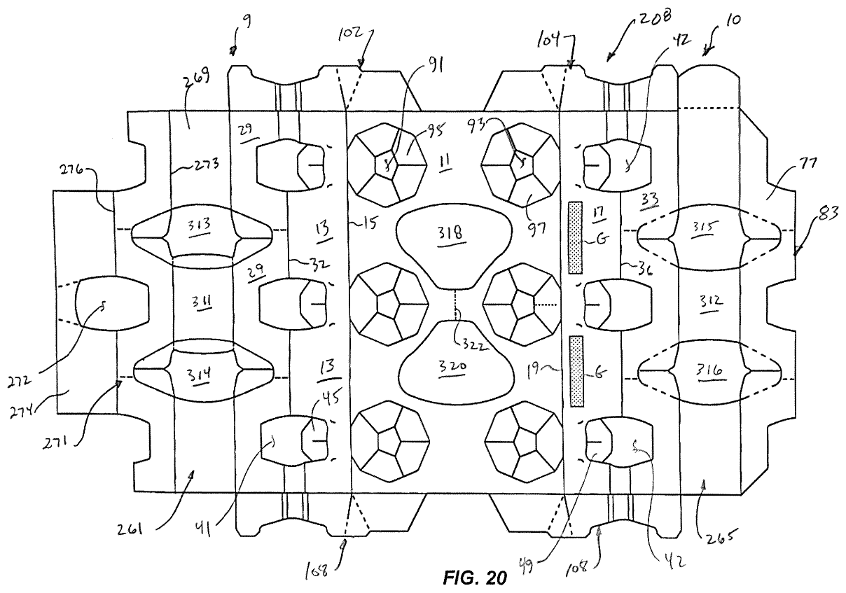

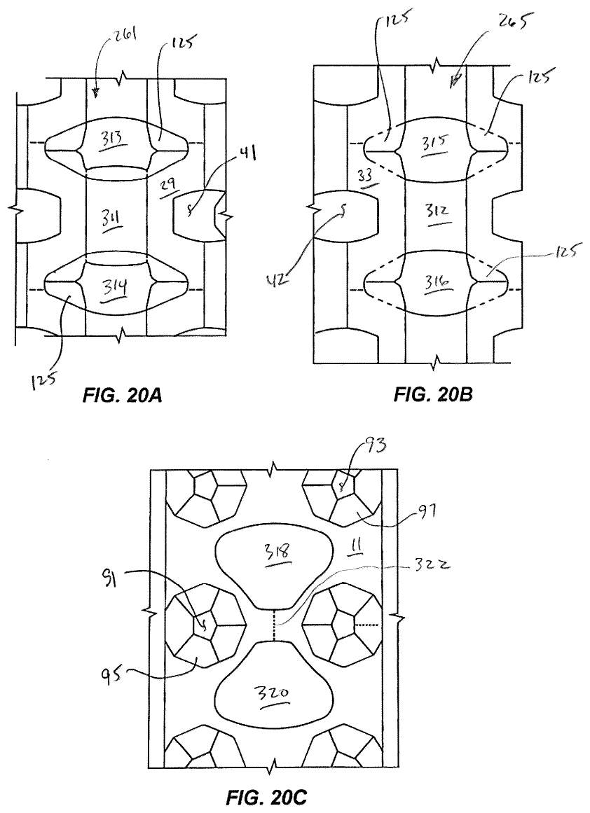

FIG. 20 shows a blank 208 for forming a carrier 201 of a package 202 (FIG. 27) according to a second embodiment of the disclosure. The second embodiment is generally similar to the prior embodiments, except for variations noted and variations that will be apparent to one of ordinary skill in the art. Accordingly, similar or identical features of the embodiments have been given like or similar reference numbers. In the second embodiment, the blank 208 can be similar to the blank 8 of the first embodiment except that the blank 208 includes handle features for forming a handle 212 of the carrier 201 that includes two main handle openings 341, 343 in the central portion of the carrier and a central handle panel 344 that extends between the two main handle openings.

As shown in FIG. 20, the front reinforcement panel 261 includes a first handle opening 313 and a second handle opening 314 and a first handle panel 311 extending between the handle openings. The front reinforcement panel 261 includes a base portion 269 and a distal portion 271 foldably connected to the base portion at a lateral fold line 273. In the second embodiment, the distal portion 271 of the front reinforcement panel 261 includes central container receiving opening 272 and a central flap 274 that surrounds the central container receiving opening and is foldable at a lateral fold line 276. In one embodiment, the blank 208 includes glue G on the back outer side panel 17 for attaching the central flap 274 to the back outer side panel when the carrier 201 is formed from the blank 208.

In one embodiment, the back reinforcement panel 265 includes a third handle opening 315 and a fourth handle opening 316 and a second handle panel 312 extending between the handle openings. The bottom panel 11, includes a fifth handle opening 318 and a sixth handle opening 320. As shown in FIG. 20, a tear line 322 extends between the fifth handle opening 318 and the sixth handle opening 320. FIGS. 20A-20C show enlarged portion of the handle features for forming the handle 212 of the carrier 201 of the second embodiment. The handle features could be otherwise shaped, arranged, configured and/or omitted without departing from the disclosure.

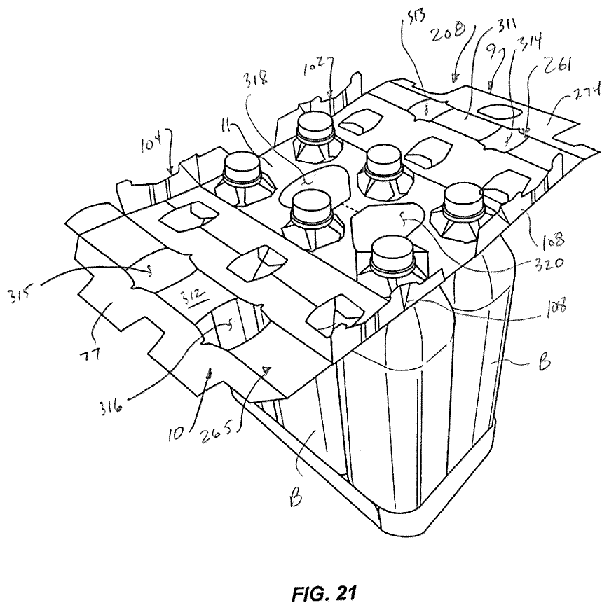

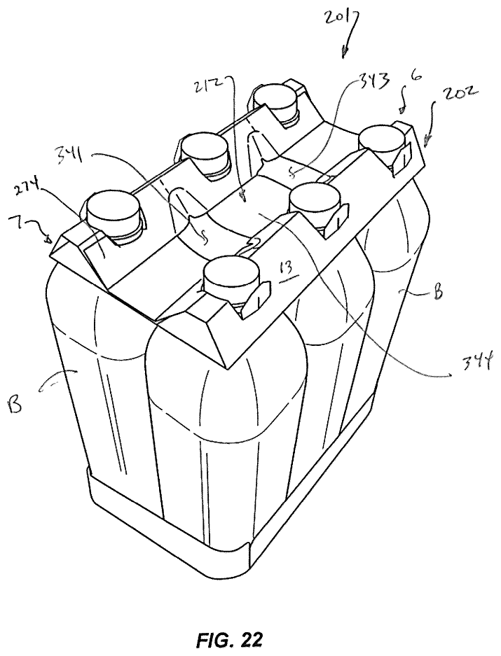

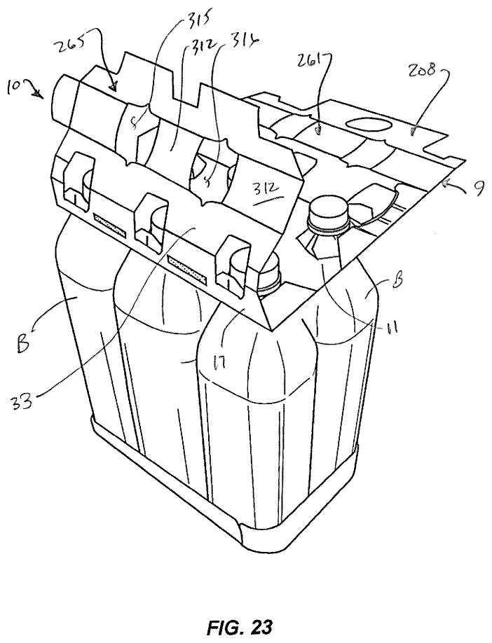

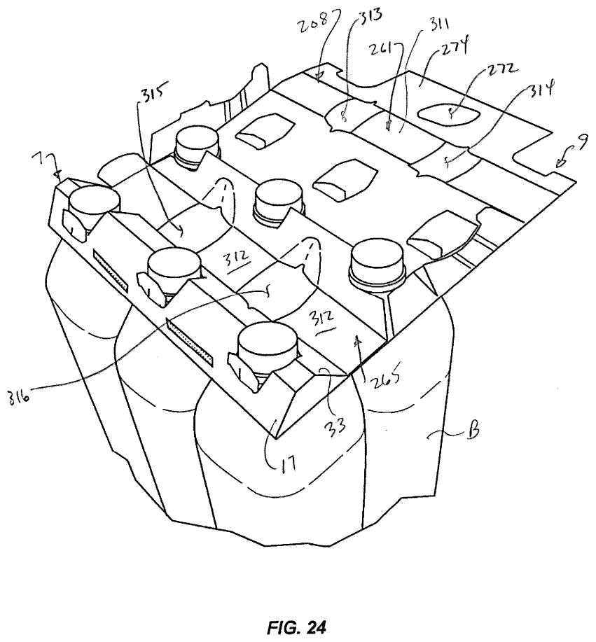

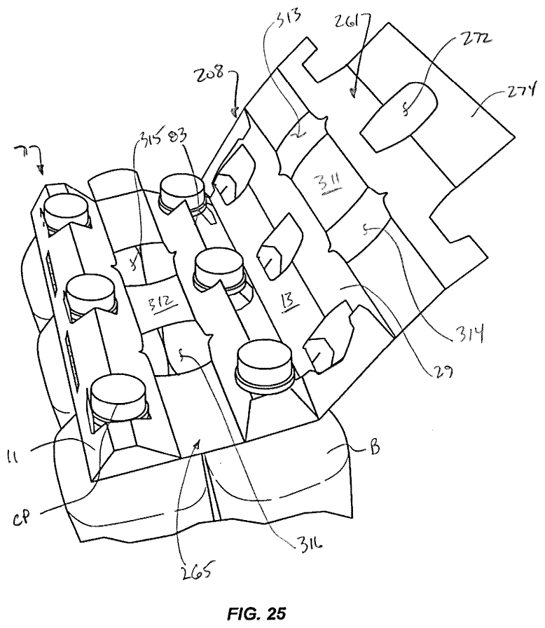

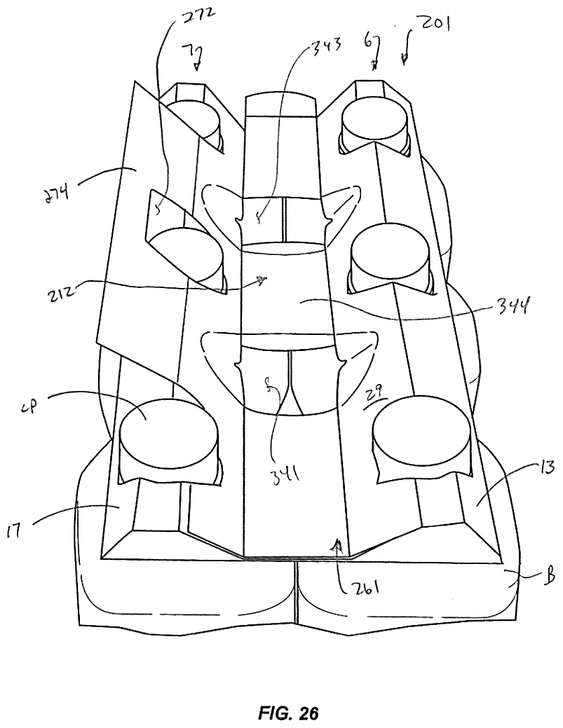

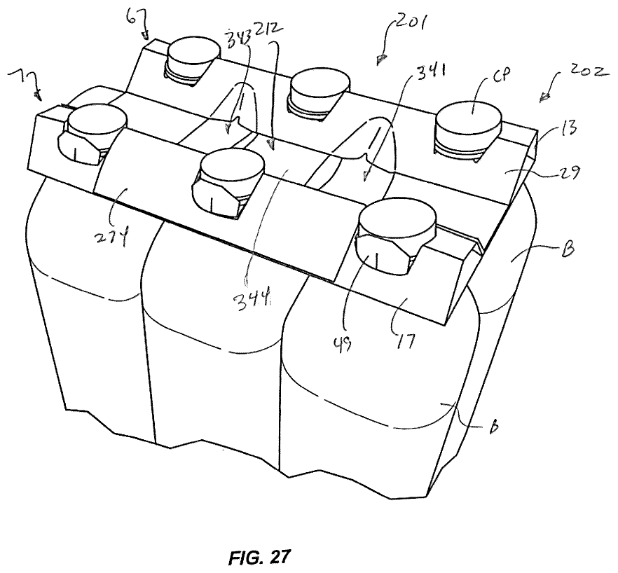

As shown in FIGS. 21-27, the blank 208 is positioned and folded to form the carrier 201 in a similar manner as the blank 8 and carrier 1 of the first embodiment. During the formation of the carrier 201, the first handle opening 313, the third handle opening 315, and the fifth handle opening 318 are overlapped and aligned to form one of the main handle opening 341 and the second handle opening 314, the fourth handle opening 316, and the sixth handle opening 320 are overlapped and aligned to form the other of the main handle openings 343 of the handle 212. Further, the first handle panel 311 and the second handle panel 312 are overlapped to form the central handle panel 344 of the handle 212.

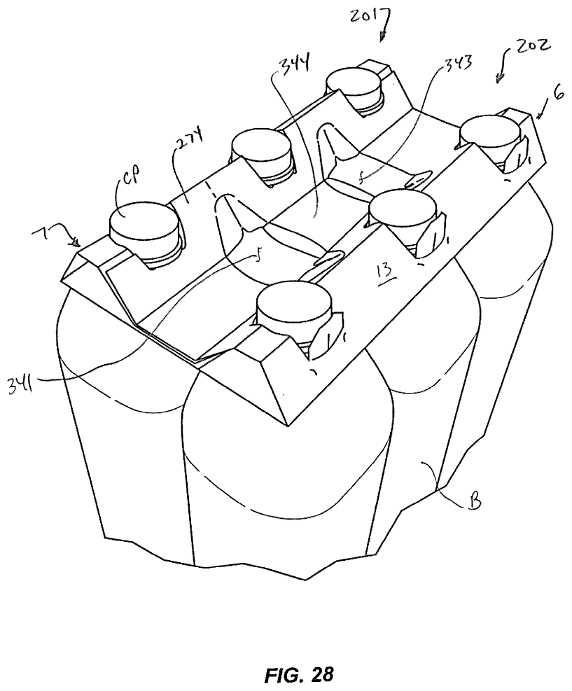

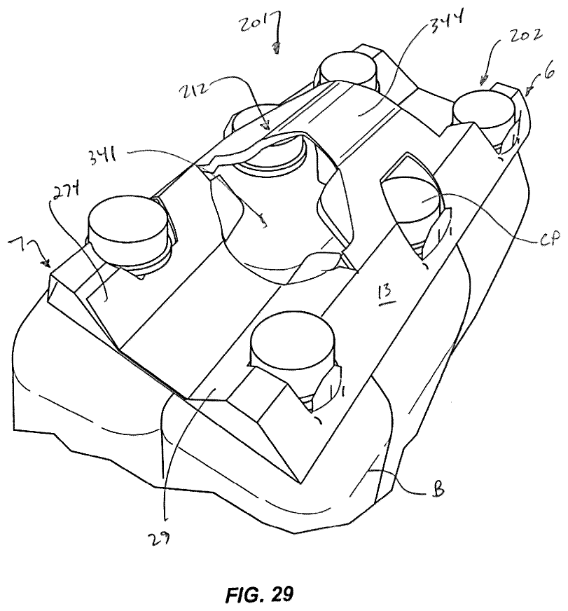

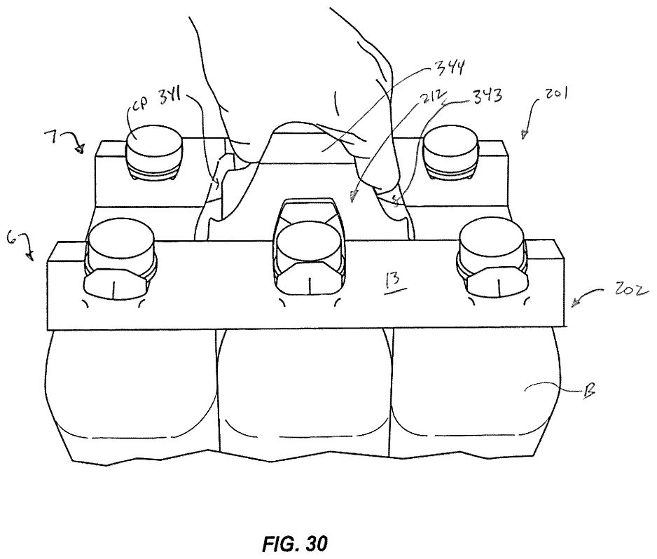

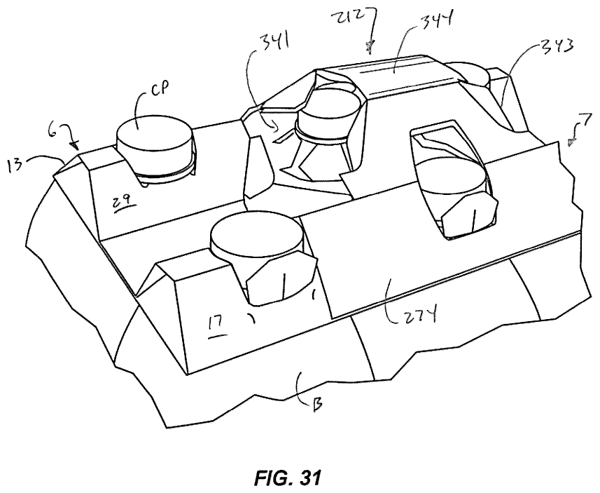

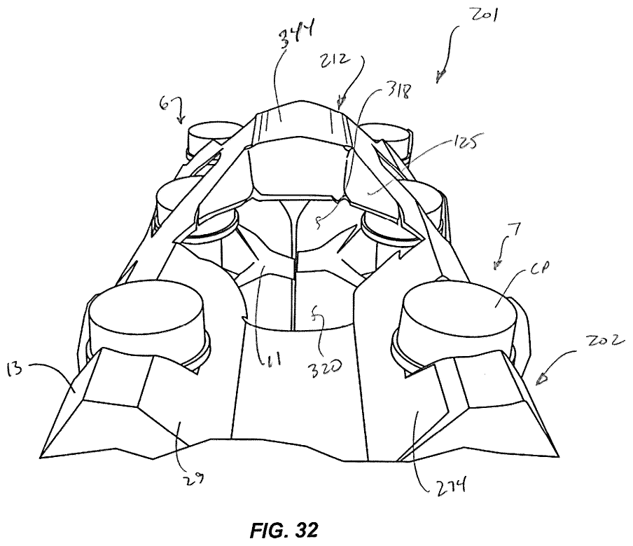

As shown in FIGS. 28-32, the handle 212 of the carrier 201 can be grasped at the central handle panel 344 by way of the main handle openings 341, 343 on either side of the openings. In one embodiment, the central handle panel 344 is configured to extend between the front row of containers and the back row of containers. As with the previous embodiments, the overlapped handle reinforcement panels facilitate grasping of the central handle panel 344 of the handle 212. As shown in FIG. 32, in some embodiments, when the central handle panel 344 is lifted to carry the carrier 201 or package 202, the tear line 322 between the handle openings 318, 320 in the bottom panel separates to allow the bottom panel to flex when lifting the carrier. In the illustrated embodiment, the central flap 274 of the front reinforcement panel 261 that overlaps and is attached to the back outer side panel 17 provides additional strength to the carrier to prevent tearing or failure of the carrier when lifting at the handle 212. The for attaching the central flap 274 to the back outer side panel when the carrier 201 is formed from the blank 208. The handle 212 can be otherwise formed and otherwise used without departing from the disclosure.

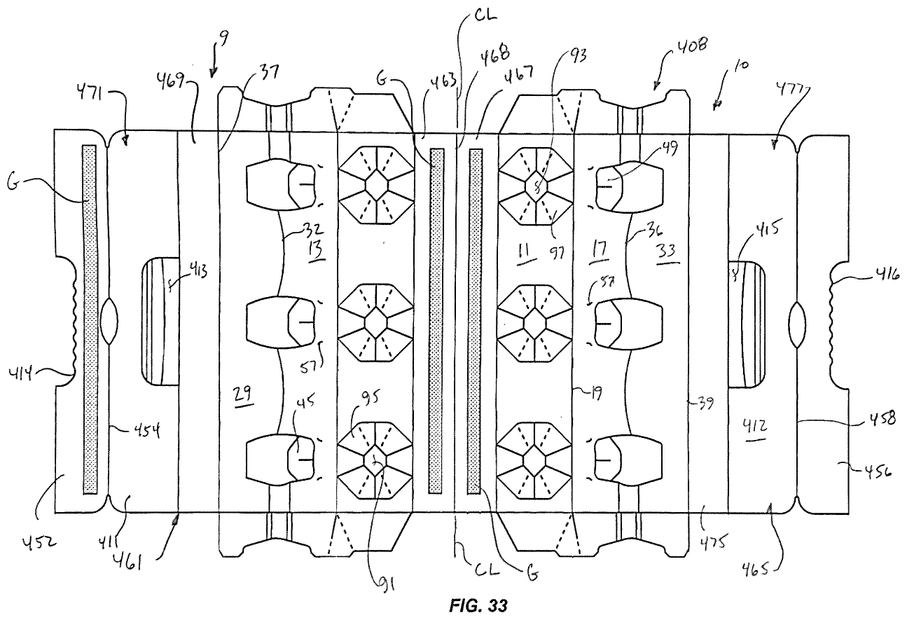

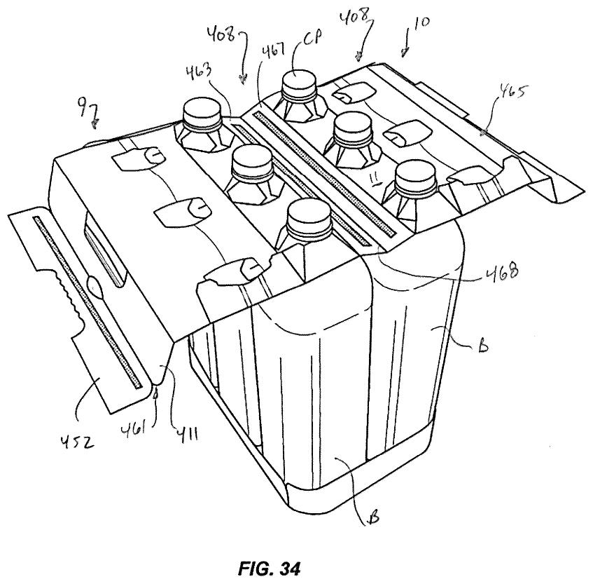

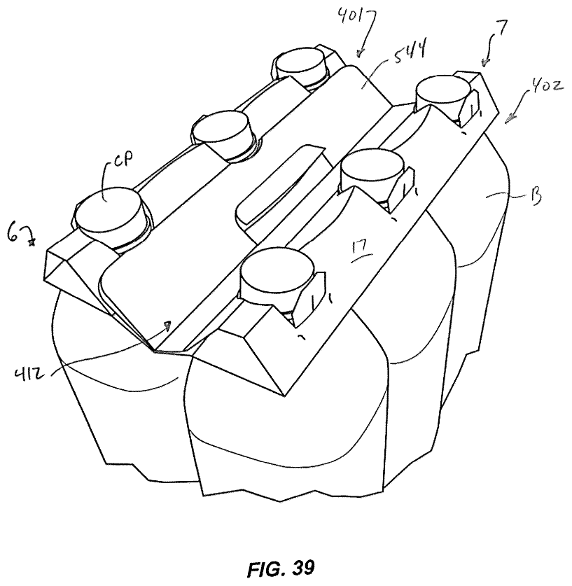

FIG. 33 shows a blank 408 for forming a carrier 401 of a package 402 (FIG. 38) according to a third embodiment of the disclosure. The third embodiment is generally similar to the prior embodiments, except for variations noted and variations that will be apparent to one of ordinary skill in the art. Accordingly, similar or identical features of the embodiments have been given like or similar reference numbers. In the third embodiment, the blank 408 can be similar to the blank 8 of the first embodiment and the blank 208 of the second embodiment except that the blank 408 includes handle features for forming a handle 412 of the carrier 401 that includes a central handle panel 544 that extends along the length of the carrier 401 between the front row and back row rows of containers B.

As shown in FIG. 33, the front reinforcement panel 461 includes a base portion 469 and a distal portion 471 foldably connected to the base portion 469. In the illustrated embodiment, the distal portion 471 includes a first handle panel 411 and a first handle reinforcement flap 452 foldably connected to the first handle panel 411 at a lateral fold line 454. In the illustrated embodiment the first handle panel 411 includes a first handle opening 413 and the first handle reinforcement flap 452 includes a second handle opening 414 in the form of a notch. In some embodiments, the first handle reinforcement flap can include glue G for attaching the first handle reinforcement flap to the first handle panel 411.

In the illustrated embodiment, the back reinforcement panel 465 is similar or identical in structure to the front reinforcement panel 461. The back reinforcement panel 465 includes a base portion 475 and a distal portion 477, the distal portion 477 includes a second handle panel 412 and a second handle reinforcement flap 456 foldably connected to the second handle panel 412 at a lateral fold line 458. In the illustrated embodiment the second handle panel 412 includes a third handle opening 415 and the second handle reinforcement flap 456 includes a fourth handle opening 416 in the form of a notch. The handle features could be otherwise shaped, arranged, configured and/or omitted without departing from the disclosure.

In the embodiment of FIG. 33, the bottom panel 11 includes two central panels 463, 467 that are foldably connected at a lateral fold line 468. In one embodiment, the lateral fold line 468 is located on a longitudinal centerline CL of the blank 408. In some embodiments, the central panels can include glue for attaching the central panels 463, 467 to a respective base portion 469, 475 of the reinforcement panels 461, 465.

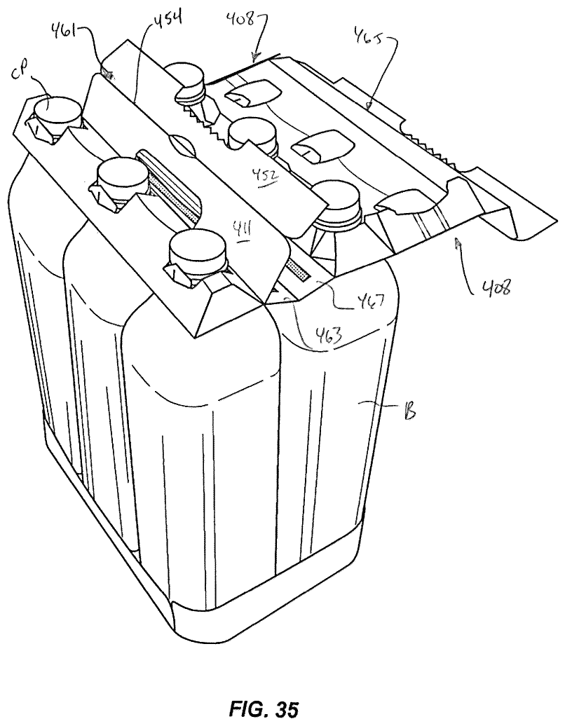

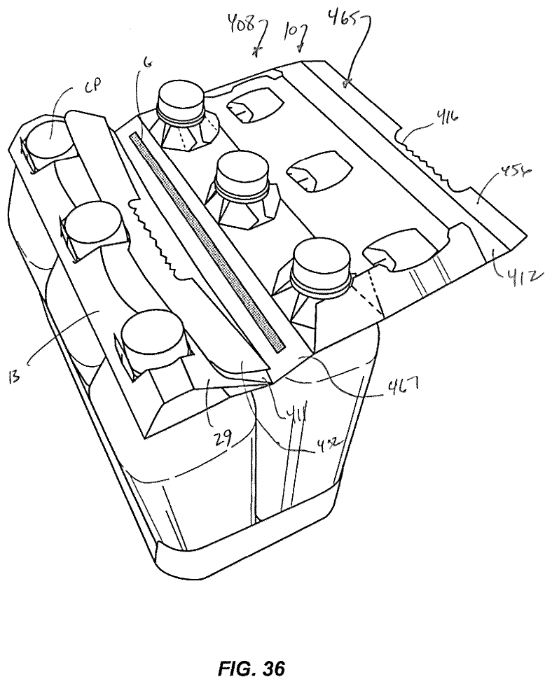

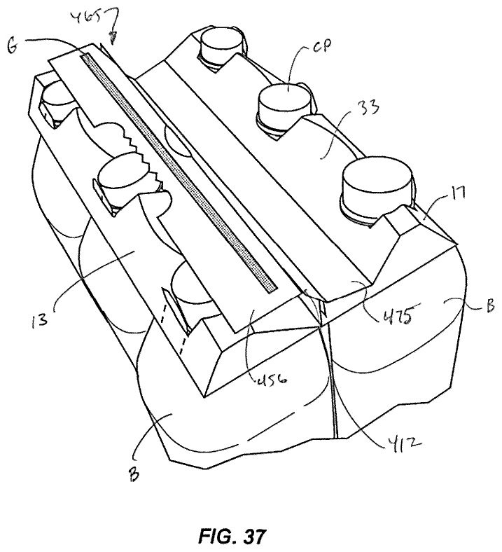

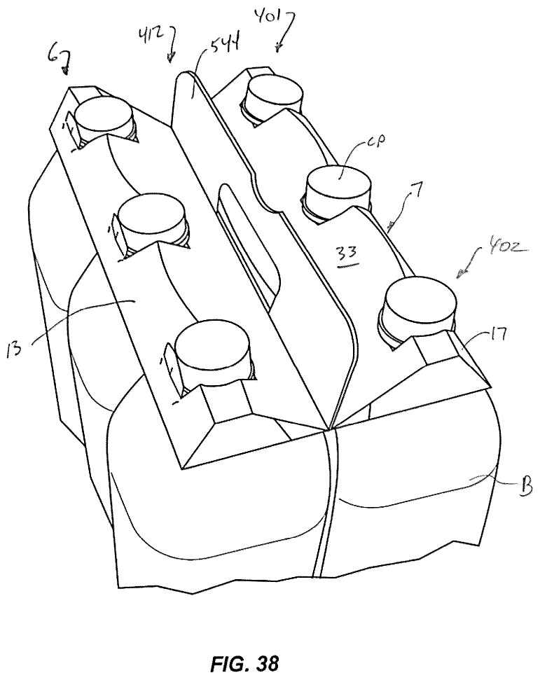

As shown in FIGS. 35-39, the blank 408 is positioned and folded to form the carrier 401 in a similar manner as the blank 8 and carrier 1 of the first embodiment and the blank 208 and carrier 201 of the second embodiment. During the formation of the carrier 401, the first handle panel 471 and the first handle reinforcement panel 452 are overlapped in face-to-face contact and the second handle panel 412 and the second handle reinforcement panel 456 are overlapped in face-to-face contact. The two layers of the first handle panel 471 and the first handle reinforcement flap 452 are brought into face-to-face contact with the two layers of the second handle panel 477 and the second handle reinforcement panel 456 to form a central handle panel 444 of the handle 412 that includes four plies or layers of material. Further, the first handle opening 413, second handle opening 414, the third handle opening 415 and the fourth handle opening 416 are aligned and overlapped of to form the central handle opening 441 adjacent the central handle panel 444.

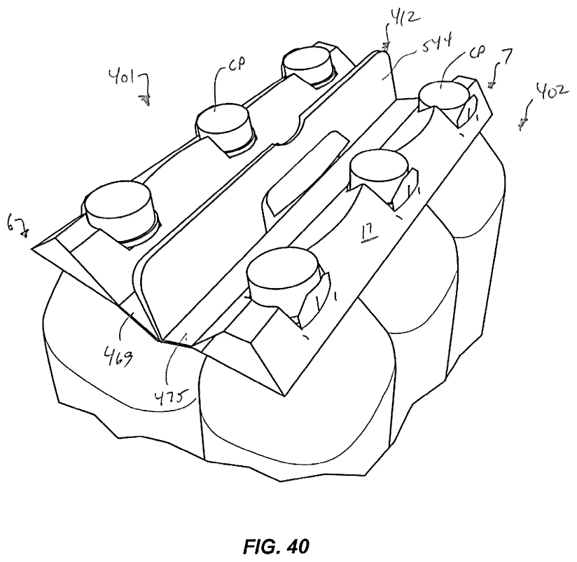

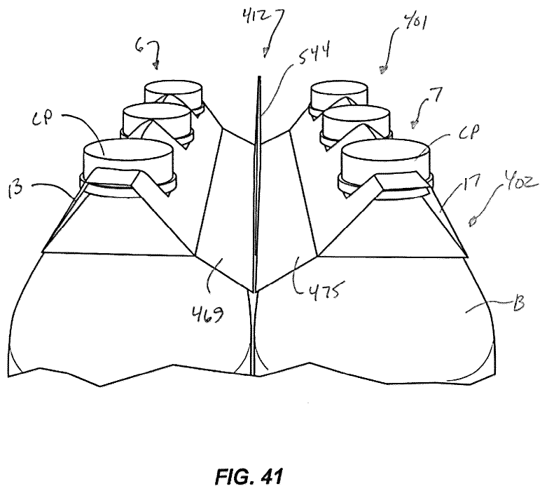

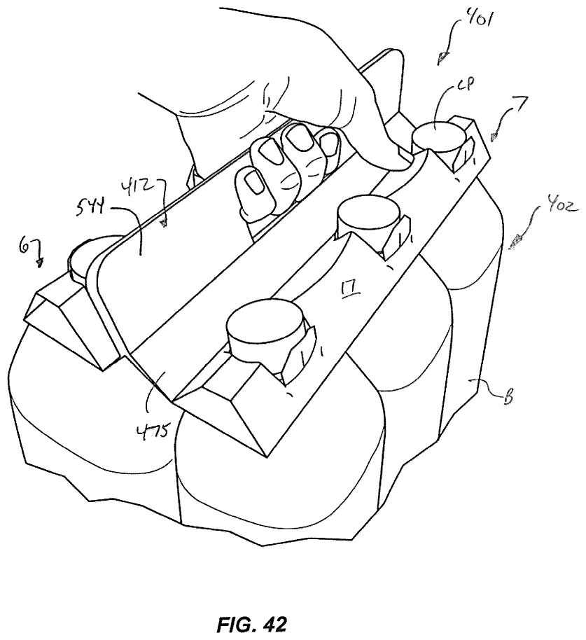

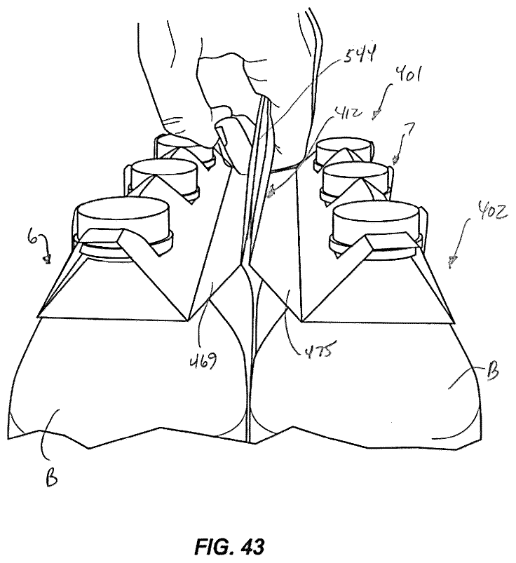

As shown in FIG. 39, the central handle panel 444 of the handle 412 of the carrier 401 can be downwardly folded to engage the caps CP or flanges F of the containers B of one of the front row of container or the back rows of containers so that the carrier 401 can be shipped and displayed without the handle 412 being in an upright position. Upon activation by a user, the handle 412 can be lifted or separated from engagement with the caps CP so that the central handle panel 444 is in an upright position (FIGS. 40 and 41). The central handle panel 444 of the handle can be grasped by a user via the central handle opening 441 and the carrier 401 and package 4020 can be lifted and carried. Upon lifting the carrier 401 via the handle 412 the central handle panel 444 can raise as the carrier flexes at the central portion of the carrier corresponding to the respective overlapped central panels 463, 467 in the bottom panel and base portion 469, 475 of the reinforcement panels 461, 465. The handle 412 can be otherwise formed and otherwise used without departing from the disclosure.

In exemplary embodiments, the clip-style carriers of the disclosed embodiments can provide increased stability, resistance, and strength, as well as a comfortable and reliable carry experience. The carriers can be adapted to be suitable for multiple bottle types, sizes, and configurations. The carriers and packages can be formed/assembled manually and/or by machine. In embodiments, the structure of the carriers can be shaped around the top portions T of the containers B (e.g., the bottle caps CP) to facilitate increasing the rigidity of the packages.

The carriers of any of the illustrated or non-illustrated embodiments of the disclosure could have other features (e.g., dispenser features, handle features, reinforcement features, etc.) without departing from the disclosure. Also, the carriers could be otherwise shaped, arranged, and/or configured and the carriers could be configured to hold articles other than beverage containers B without departing from the disclosure.

Any of the features of the various embodiments of the disclosure can be combined with, replaced by, or otherwise configured with other features of other embodiments of the disclosure without departing from the scope of this disclosure. The carrier styles and panel configurations described above are included by way of example.

In general, the blanks may be constructed from paperboard having a caliper so that it is heavier and more rigid than ordinary paper. The blanks can also be constructed of other materials, such as cardboard, or any other material having properties suitable for enabling the package to function at least generally as described above.

The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

The above embodiments may be described as having one or panels adhered together by glue. The term “glue” is intended to encompass all manner of adhesives commonly used to secure paperboard carton panels in place.

The term “line” as used herein includes not only straight lines, but also other types of lines such as curved, curvilinear or angularly displaced lines.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The foregoing description of the disclosure illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments, but other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure without departing from the scope of the disclosure.

Additionally, spatially relative terms, such as “bottom or “top”; or “front” or “back”; and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” “exemplary embodiments”, or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” “in some embodiments”, or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A carrier for at least partially holding a plurality of containers, the carrier comprising:
a bottom panel for at least partially receiving a respective container of the plurality of containers, the bottom panel having container retention features for at least partially engaging a respective container of the plurality of containers, the plurality of container retention features comprising a respective bottom container retention opening and a respective plurality of bottom container retention flaps foldably connected to the bottom panel and cooperating with the bottom container retention opening to engage a respective container of the plurality of containers;
a front portion, the front portion comprising a first portion of the bottom panel including front bottom container retention features of the plurality of bottom container retention features, at least one front side panel, and a front reinforcement panel;
a back portion, the back portion comprising a second portion of the bottom panel including back bottom container retention features of the plurality of bottom container retention features, at least one back side panel, and a back reinforcement panel;
a reinforcement portion extending from the front portion to the back portion for reinforcing the carrier, the reinforcement portion comprises the front reinforcement panel and the back reinforcement panel in at least partial face-to-face contact; and
handle features for forming a handle for grasping and carrying the carrier, the handle features comprising a first handle feature in the front reinforcement panel and a second handle feature in the back reinforcement panel, the first handle feature and the second handle feature form the handle.

2. The carrier of claim 1, wherein the first handle feature comprises a first handle panel and the second handle feature comprises a second handle panel that are in face-to-face contact to form a central handle panel.

3. The carrier of claim 2, wherein the first handle features comprise a first handle reinforcement flap foldably connected to the first handle panel and the second handle features comprise a second handle reinforcement flap foldably connected to the second handle panel.

4. The carrier of claim 3, wherein the central handle panel comprises four plies of material.

5. The carrier of claim 2, wherein the central handle panel extends between two rows of containers of the plurality of containers.

6. The carrier of claim 5, wherein the central handle panel is positionable between a lowered position in contact with one of the front portion and the back portion and a raised position wherein the central panel extends upright between the front portion and the back portion.

7. The carrier of claim 1, wherein the handle features comprise a first handle opening in the front reinforcement panel and a second handle opening in the back reinforcement panel, the first handle opening the second handle opening being aligned to form a handle opening of the handle.

8. The carrier of claim 7, wherein the handle features further comprise a third handle opening in the bottom panel, the third handle opening is aligned with the first handle opening and the second handle opening to form the handle opening.

9. The carrier of claim 8, wherein the handle features further comprise an access feature for cooperating with the handle opening to form the handle.

10. The carrier of claim 9, wherein the access feature comprises a first access feature in the front reinforcement panel and a second access feature in the back reinforcement panel that are aligned to form the access feature of the handle.

11. The carrier of claim 9, wherein the access feature comprises a third access feature in the bottom panel, the third access feature is aligned with the first access feature and the second access feature to form the access feature of the handle.

12. The carrier of claim 9, wherein the access feature is a first access feature spaced apart from the handle opening and the access feature comprises a second access feature spaced apart from the handle opening, the second access feature comprises an overlapped portion of the front reinforcement panel and the back reinforcement panel at an edge of the carrier.

13. The carrier of claim 12, wherein the handle is configured for grasping the carrier at the handle opening and one of the first access feature and the second access feature.

14. The carrier of claim 2, wherein the first handle features comprise a first handle opening and a second handle opening adjacent the first handle panel.

15. The carrier of claim 14, wherein the second handle features comprise a third handle opening and a fourth handle opening adjacent the second handle panel.

16. The carrier of claim 15, wherein the first handle opening is aligned with the third handle opening adjacent a first side of the central handle panel and the second handle opening is aligned with the fourth handle opening adjacent a second side of the central handle panel.

17. The carrier of claim 16, wherein the first handle features comprise first tear lines extending from the first handle opening and the second handle opening, the second handle features comprise second tear lines extending from the third handle opening and the fourth handle opening, the first tear lines cooperating with the second tear lines to form reinforcement portions of the handle.

18. The carrier of claim 16, wherein the handle features further comprise third handle features in the bottom panel, the third handle features comprises a fifth handle opening aligned with the first handle opening and the third handle opening, and a sixth handle opening aligned with the second handle opening and the fourth handle opening.

19. The carrier of claim 18, wherein the third handle features comprises a line of weakening extending between the fifth handle opening and the sixth handle opening.

20. The carrier of claim 15, wherein the front reinforcement panel is foldably connected to the at least one front side panel and the back reinforcement panel is foldably connected to the at least one back side panel.

21. The carrier of claim 20, wherein each of the front reinforcement panel and the back reinforcement panel comprises a base portion and a distal portion, the base portion of the front reinforcement panel comprises the first handle panel and the base portion of the back reinforcement panel comprises the second handle panel.

22. The carrier of claim 21, wherein the distal portion of the front reinforcement panel has container engaging features for engaging a respective container in the back portion of the carrier and the distal portion of the back reinforcement panel has container engaging features for engaging a respective container in the front portion of the carrier.

23. A blank for forming a carrier for holding a plurality of containers, the blank comprising:
a bottom panel for at least partially receiving a respective container of the plurality of containers in the carrier formed from the blank, the bottom panel having a plurality of container retention features for at least partially engaging a respective container of the plurality of containers, the plurality of container retention features comprising a respective bottom container retention opening and a respective plurality of bottom container retention flaps foldably connected to the bottom panel and cooperating with the bottom container retention opening to engage a respective container of the plurality of containers in the carrier formed from the blank;
a front portion for forming a front portion of the carrier formed from the blank, the front portion of the blank comprising a first portion of the bottom panel including front bottom container retention features of the plurality of bottom container retention features, at least one front side panel, and a front reinforcement panel;
a back portion for forming a back portion of the carrier formed from the blank, the back portion of the blank comprising a second portion of the bottom panel including back bottom container retention features of the plurality of bottom container retention features, at least one back side panel, and a back reinforcement panel;
the front reinforcement panel and the back reinforcement panel are for being in at least partial face-to-face contact in the carrier formed from the blank and for forming a reinforcement portion extending from the front portion of the carrier to the back portion of the carrier and for reinforcing the carrier formed from the blank; and
handle features for forming a handle in the carrier formed from the blank, the handle features comprising a first handle feature in the front reinforcement panel and a second handle feature in the back reinforcement panel, the first handle feature and the second handle feature cooperate to form the handle in the carrier formed from the blank.

24. The blank of claim 23, wherein the first handle feature comprises a first handle panel and the second handle feature comprises a second handle panel that are for being in face-to-face contact to form a central handle panel in the carrier formed from the blank.

25. The blank of claim 24, wherein the first handle features comprise a first handle reinforcement flap foldably connected to the first handle panel and the second handle features comprise a second handle reinforcement flap foldably connected to the second handle panel.

26. The blank of claim 23, wherein the handle features comprise a first handle opening in the front reinforcement panel and a second handle opening in the back reinforcement panel, the first handle opening and the second handle opening are for being aligned to form a handle opening of the handle in the carrier formed from the blank.

27. The blank of claim 26, wherein the handle features further comprise a third handle opening in the bottom panel, the third handle opening is for being aligned with the first handle opening and the second handle opening to form the handle opening in the carrier formed from the blank.

28. The blank of claim 27, wherein the handle features further comprise an access feature for cooperating with the handle opening to form the handle in the carrier formed from the blank, the access feature comprises a first access feature in the front reinforcement panel and a second access feature in the back reinforcement panel that are for being aligned to form the access feature of the handle in the carrier formed from the blank.

29. The blank of claim 28, wherein the access feature comprises a third access feature in the bottom panel, the third access feature is for being aligned with the first access feature and the second access feature to form the access feature of the handle in the carrier formed from the blank.

30. The blank of claim 24, wherein the first handle features comprise a first handle opening and a second handle opening adjacent the first handle panel.

31. The blank of claim 30, wherein the second handle features comprise a third handle opening and a fourth handle opening adjacent the second handle panel.

32. The blank of claim 31, wherein the first handle opening is for being aligned with the third handle opening adjacent a first side of the central handle panel and the second handle opening is for being aligned with the fourth handle opening adjacent a second side of the central handle panel.

33. The blank of claim 32, wherein the first handle features comprise first tear lines extending from the first handle opening and the second handle opening, the second handle features comprise second tear lines extending from the third handle opening and the fourth handle opening, the first tear lines cooperating with the second tear lines to form reinforcement portions of the handle in the carrier formed from the blank.

34. The blank of claim 32, wherein the handle features further comprise third handle features in the bottom panel, the third handle features comprises a fifth handle opening for being aligned with the first handle opening and the third handle opening, and a sixth handle opening for being aligned with the second handle opening and the fourth handle opening in the carrier formed from the blank.

35. The blank of claim 34, wherein the third handle features comprises a line of weakening extending between the fifth handle opening and the sixth handle opening.

36. The blank of claim 31, wherein the front reinforcement panel is foldably connected to the at least one front side panel and the back reinforcement panel is foldably connected to the at least one back side panel.

37. The blank of claim 36, wherein each of the front reinforcement panel and the back reinforcement panel comprises a base portion and a distal portion, the base portion of the front reinforcement panel comprises the first handle panel and the base portion of the back reinforcement panel comprises the second handle panel.

38. The blank of claim 37, wherein the distal portion of the front reinforcement panel has container engaging features for engaging a respective container in the back portion of the carrier formed from the blank and the distal portion of the back reinforcement panel has container engaging features for engaging a respective container in the front portion of the carrier formed from the blank.

39. A method of forming a carrier for holding a plurality of containers, the method comprising:
obtaining a blank, the blank comprising a bottom panel having a plurality of container retention features comprising a respective bottom container retention opening and a respective plurality of bottom container retention flaps foldably connected to the bottom panel;
the blank comprising a front portion and a back portion, the front portion of the blank comprising a first portion of the bottom panel including front bottom container retention features of the plurality of bottom container retention features, at least one front side panel, and a front reinforcement panel, the back portion of the blank comprising a second portion of the bottom panel including back bottom container retention features of the plurality of bottom container retention features, at least one back side panel, and a back reinforcement panel, the blank comprises handle features comprising a first handle feature in the front reinforcement panel and a second handle feature in the back reinforcement panel;
positioning the bottom panel to engage a respective container of the plurality of containers and the bottom container retention flaps cooperate with bottom container retention openings to engage a respective container of the plurality of containers;
forming a front portion of the carrier from the front portion of the blank and forming a back portion of the carrier from the back portion of the blank; and
forming a reinforcement portion of the carrier extending between the front portion of the carrier and the back portion of the carrier by positioning the front reinforcement panel and the back reinforcement panel in at least partially face-to-face contact to reinforce the carrier, the forming the reinforcement portion comprises forming a handle by positioning the first handle feature and the second handle feature.

40. The method of claim 39, wherein the first handle feature comprises a first handle panel and the second handle feature comprises a second handle panel, the forming the handle comprises positioning the first handle panel and the second handle panel in face-to-face contact to form a central handle panel.

41. The method of claim 40, wherein the first handle features comprise a first handle reinforcement flap foldably connected to the first handle panel and the second handle features comprise a second handle reinforcement flap foldably connected to the second handle panel, and the central handle panel comprises four plies of material.

42. The method of claim 40, wherein the central handle panel extends between two rows of containers of the plurality of containers.

43. The method of claim 42, wherein the central handle panel is positionable between a lowered position in contact with one of the front portion and the back portion and a raised position wherein the central panel extends upright between the front portion and the back portion.

44. The method of claim 39, wherein the handle features comprise a first handle opening in the front reinforcement panel and a second handle opening in the back reinforcement panel, the forming the handle comprises aligning the first handle opening and the second handle opening to form a handle opening of the handle.

45. The method of claim 44, wherein the handle features further comprise a third handle opening in the bottom panel, the forming the handle comprises aligning the third handle opening with the first handle opening and the second handle opening to form the handle opening.

46. The method of claim 45, wherein the handle features further comprise an access feature for cooperating with the handle opening to form the handle.

47. The method of claim 46, wherein the access feature comprises a first access feature in the front reinforcement panel and a second access feature in the back reinforcement panel that are aligned to form the access feature of the handle.

48. The method of claim 47, wherein the access feature comprises a third access feature in the bottom panel, the third access feature is aligned with the first access feature and the second access feature to form the access feature of the handle.

49. The method of claim 46, wherein the access feature is a first access feature spaced apart from the handle opening and the access feature comprises a second access feature spaced apart from the handle opening, the second access feature comprises an overlapped portion of the front reinforcement panel and the back reinforcement panel at an edge of the carrier.

50. The method of claim 49, wherein the forming the handle comprises positioning the handle for grasping the carrier at the handle opening and one of the first access feature and the second access feature.

51. The method of claim 40, wherein the first handle features comprise a first handle opening and a second handle opening adjacent the first handle panel.

52. The method of claim 51, wherein the second handle features comprise a third handle opening and a fourth handle opening adjacent the second handle panel.

53. The method of claim 52, wherein the forming the handle comprises aligning the first handle opening with the third handle opening adjacent a first side of the central handle panel and aligning the second handle opening with the fourth handle opening adjacent a second side of the central handle panel.

54. The method of claim 53, wherein the first handle features comprise first tear lines extending from the first handle opening and the second handle opening, the second handle features comprise second tear lines extending from the third handle opening and the fourth handle opening, the first tear lines cooperating with the second tear lines to form reinforcement portions of the handle.

55. The method of claim 53, wherein the handle features further comprise third handle features in the bottom panel, the third handle features comprises a fifth handle opening aligned with the first handle opening and the third handle opening, and a sixth handle opening aligned with the second handle opening and the fourth handle opening.

56. The method of claim 55, wherein the third handle features comprises a line of weakening extending between the fifth handle opening and the sixth handle opening.

57. The method of claim 52, wherein the front reinforcement panel is foldably connected to the at least one front side panel and the back reinforcement panel is foldably connected to the at least one back side panel, each of the front reinforcement panel and the back reinforcement panel comprises a base portion and a distal portion, the base portion of the front reinforcement panel comprises the first handle panel and the base portion of the back reinforcement panel comprises the second handle panel.

58. The method of claim 57, wherein the distal portion of the front reinforcement panel has container engaging features for engaging a respective container in the back portion of the carrier and the distal portion of the back reinforcement panel has container engaging features for engaging a respective container in the front portion of the carrier.
